(19) United States
(12) Patent Application Publication
(10) Pub. No.: US 2013/0065987 A1
(43) Pub. Date: Mar. 14, 2013

(54) THERMAL CONDUCTIVE SHEET AND PRODUCING METHOD THEREOF

(71) Applicants: Saori Fukuzaki, Osaka (JP); Keisuke Hirano, Osaka (JP); Seiji Izutani, Osaka (JP)

(72) Inventors: Saori Fukuzaki, Osaka (JP); Keisuke Hirano, Osaka (JP); Seiji Izutani, Osaka (JP)

(73) Assignee: NITTO DENKO CORPORATION, Osaka (JP)

(21) Appl. No.: 13/611,372

(22) Filed: Sep. 12, 2012

(30) Foreign Application Priority Data
Sep. 13, 2011 (JP) 2011-199910

(51) Int. Cl. C08L 63/02; B29C 43/00; C08K 3/28; C08K 3/38; C08K 3/22

(52) U.S. Cl. 523/445; 523/400; 523/457; 264/331.11

(57) ABSTRACT

A thermal conductive sheet has a peeling adhesive force with respect to a copper foil of 2 N/10 mm or more, a thermal conductivity in a thickness direction (TC1) of 4 W/m·K or more, a thermal conductivity in a direction perpendicular to the thickness direction (TC2) of 20 W/m·K or more, and a ratio (TC2/TC1) of the thermal conductivity in a direction perpendicular to the thickness direction (TC2) with respect to the thermal conductivity in the thickness direction (TC1) of 3 or more.

### CROSS-REFERENCE TO RELATED APPLICATION

The present application claims priority from Japanese Patent Application No. 2011-199910 filed on Sep. 13, 2011, the contents of which are hereby incorporated by reference into this application.

### BACKGROUND OF THE INVENTION

1. Field of the Invention

The present invention relates to a thermal conductive sheet and a producing method thereof, to be specific, to a thermal conductive sheet used for various heat dissipating applications and a producing method thereof.

2. Description of Related Art

In recent years, power electronics technology which uses semiconductor elements to convert and control electric power has been applied in hybrid devices, high-brightness LED devices, electromagnetic induction heating devices, or the like. In power electronics technology, a high current is converted to heat or the like and therefore, materials which are disposed in the semiconductor element are required to have excellent heat dissipating properties (an excellent thermal conductivity). The above-described materials are also required to have an excellent adhesiveness with respect to the semiconductor element so as to be surely disposed in the semiconductor element.

A thermal conductive sheet in which, for example, an inorganic filler having a thermal conductivity, to be specific, a boron nitride in an aggregated sphere shape and an aluminum oxide in a sphere shape are dispersed in an epoxy resin having an adhesiveness has been proposed (ref: for example, Japanese Unexamined Patent Publication No. 2008-297429).

### SUMMARY OF THE INVENTION

In recent years, according to its use and purpose, the thermal conductive sheet is required to dissipate heat in a direction along the semiconductor element in which the thermal conductive sheet is disposed, that is, a direction perpendicular to the thickness direction (the plane direction) of the thermal conductive sheet. In such a case, among all, the thermal conductive sheet is required to further improve the thermal conductivity in the plane direction. However, there is a disadvantage that the thermal conductivity of the thermal conductive sheet described in Japanese Unexamined Patent Publication No. 2008-297429 is isotropic, that is, the thermal conductivity in the thickness direction is similar to that in the plane direction, so that the requirement cannot be satisfied.

In the thermal conductive sheet in Japanese Unexamined Patent Publication No. 2008-297429, it has been tentatively proposed that the mixing proportion of the inorganic filler is increased so as to further improve the thermal conductivity in the plane direction. In such a case, there is a disadvantage that the adhesiveness is significantly reduced and the reliability is reduced.

It is an object of the present invention to provide a thermal conductive sheet which has both an excellent adhesiveness and an excellent thermal conductivity in a direction perpendicular to the thickness direction, and a producing method thereof.

A thermal conductive sheet of the present invention has a peeling adhesive force with respect to a copper foil of 2 N/10 mm or more, a thermal conductivity in a thickness direction (TC1) of 4 W/m·K or more, a thermal conductivity in a direction perpendicular to the thickness direction (TC2) of 20 W/m·K or more, and a ratio (TC2/TC1) of the thermal conductivity in a direction perpendicular to the thickness direction (TC2) with respect to the thermal conductivity in the thickness direction (TC1) of 3 or more.

In the thermal conductive sheet of the present invention, it is preferable that the thermal conductive sheet contains a filler containing a plate-like particle and a non-plate-like particle, and an epoxy resin and the content ratio of the filler is 40 volume % or more.

In the thermal conductive sheet of the present invention, it is preferable that the content ratio of the plate-like particle with respect to the non-plate-like particle is 4/3 to 6/1 on the volume basis.

In the thermal conductive sheet of the present invention, it is preferable that the aspect ratio of the plate-like particle is 2 or more and 10000 or less.

In the thermal conductive sheet of the present invention, it is preferable that the aspect ratio of the non-plate-like particle is 1 or more and less than 2.

In the thermal conductive sheet of the present invention, it is preferable that the plate-like particle is made of a boron nitride.

In the thermal conductive sheet of the present invention, it is preferable that the non-plate-like particle is made of at least one inorganic component selected from the group consisting of a metal oxide, a metal hydroxide, and a metal nitride.

In the thermal conductive sheet of the present invention, it is preferable that the non-plate-like particle is made of at least one aluminum compound selected from the group consisting of an aluminum oxide, an aluminum hydroxide, and an aluminum nitride.

In the thermal conductive sheet of the present invention, it is preferable that the average value of the maximum length of the plate-like particle is 1 to 100 μm.

In the thermal conductive sheet of the present invention, it is preferable that the average value of the maximum length of the non-plate-like particle is 1 to 100 μm.

A method for producing a thermal conductive sheet of the present invention includes the steps of preliminarily preparing a resin composition which contains a filler containing a plate-like particle and a non-plate-like particle, and an epoxy resin and in which the content ratio of the filler is 40 volume % or more; and forming the resin composition into a sheet shape by a hot pressing.

The thermal conductive sheet of the present invention obtained by the method for producing a thermal conductive sheet of the present invention has a peeling adhesive force with respect to a copper foil of 2 N/10 mm or more, so that it has an excellent adhesive force.

The thermal conductive sheet of the present invention has a thermal conductivity in a thickness direction (TC1) of 4 W/m·K or more, a thermal conductivity in a direction perpendicular to the thickness direction (TC2) of 20 W/m·K or more, and a ratio (TC2/TC1) of the thermal conductivity in a direction perpendicular to the thickness direction (TC2) with respect to the thermal conductivity in the thickness direction (TC1) of 3 or more, so that it has an excellent thermal conductivity in a direction perpendicular to the thickness direction.

Therefore, the thermal conductive sheet of the present invention has both an excellent adhesiveness and an excellent thermal conductivity in a direction perpendicular to the thickness direction.

Therefore, the thermal conductive sheet of the present invention, as a thermal conductive sheet having an excellent thermal conductivity in a direction perpendicular to the thickness direction while having an excellent adhesiveness, can be used for various heat dissipating applications.

### BRIEF DESCRIPTION OF THE DRAWINGS

FIG. 1 shows a perspective view for illustrating one embodiment of a thermal conductive sheet of the present invention.

### DETAILED DESCRIPTION OF THE INVENTION

A composition of a thermal conductive sheet of the present invention is not particularly limited as long as the thermal conductive sheet has a peeling adhesive force and a thermal conductivity to be described later. The thermal conductive sheet of the present invention contains, for example, a filler and a resin.

An example of a component for forming the filler includes an inorganic component. Examples of the inorganic component include oxide, hydroxide, nitride, carbide, a metal, and a carbonaceous material.

An example of the oxide includes a metal oxide such as aluminum oxide (alumina, including a hydrate of aluminum oxide), iron oxide, magnesium oxide (magnesia), titanium oxide (titania), cerium oxide (ceria), and zirconium oxide (zirconia). Also, examples of the oxide include a composite metal oxide such as barium titanate and furthermore, a doped metal oxide such as indium tin oxide and antimony tin oxide obtained by doping a metal ion thereto. In addition, an example of the oxide also includes a non-metal oxide such as silicon oxide (silica).

An example of the hydroxide includes a metal hydroxide such as aluminum hydroxide, calcium hydroxide, and magnesium hydroxide.

An example of the nitride includes a metal nitride such as aluminum nitride, gallium nitride, chromium nitride, tungsten nitride, magnesium nitride, molybdenum nitride, and lithium nitride. In addition, an example of the nitride also includes a non-metal nitride such as silicon nitride and boron nitride.

An example of the carbide includes a metal carbide such as aluminum carbide, titanium carbide, and tungsten carbide. In addition, an example of the carbide also includes a non-metal carbide such as silicon carbide and boron carbide.

Examples of the metal include copper, gold, nickel, tin, iron, or alloys thereof.

Examples of the carbonaceous material include carbon black, graphite, diamond, fullerene, a carbon nanotube, a carbon nanofiber, a nanohorn, a carbon maicrocoil, and a nanocoil.

Examples of the shape of the filler include a plate-like shape and a non-plate like shape. An example of the plate-like shape includes a flake-like shape. The non-plate-like shape is a shape other than the plate-like shape and examples of the non-plate-like shape include a sphere-like shape, a block-like shape, and a needle-like shape.

In other words, examples of the filler include a plate-like particle and a non-plate-like particle.

An example of the plate-like particle includes a plate-like particle made of the above-described inorganic component. Preferably, examples of the plate-like particle include a plate-like particle made of an oxide (a plate-like oxide particle) and a plate-like particle made of a nitride (a plate-like nitride particle).

To be specific, an example of the plate-like oxide particle includes a plate-like metal oxide particle such as a plate-like aluminum oxide monohydrate particle and a plate-like magnesium oxide particle.

Examples of the plate-like nitride particle include a plate-like non-metal nitride particle such as a plate-like boron nitride particle and a plate-like metal nitride particle such as a plate-like aluminum nitride particle.

As the plate-like particle, preferably, a plate-like nitride particle is used, or more preferably, a plate-like non-metal nitride particle is used.

These plate-like particles can be used alone or in combination of two or more.

The average particle size (the average value of the maximum length) of the plate-like particle is, for example, 1 μm or more, preferably 3 μm or more, furthermore 5 μm or more, furthermore 10 μm or more, furthermore 20 μm or more, furthermore 30 μm or more, or furthermore 40 μm or more, and is usually, for example, 100 μm or less, or preferably 90 μm or less. The average particle size (the average value of the maximum length) of the plate-like particle is, for example, 1 to 100 μm, or preferably 3 to 90 μm.

The average value of the maximum length of the plate-like particle is measured by, for example, a light scattering method. To be specific, the average value of the maximum length of the plate-like particle is a volume average particle size measured with a dynamic light scattering type particle size distribution analyzer.

When the average value of the maximum length of the plate-like particle exceeds the above-described range, the thermal conductive sheet may become fragile. When the average value of the maximum length of the plate-like particle is below the above-described range, the thermal conductivity in the plane direction may be reduced.

The thickness of the plate-like particle, that is, the average value of the length in a direction perpendicular to the maximum length direction is, for example, 0.01 to 20 μm, or preferably 0.1 to 15 μm.

The thickness of the plate-like particle is measured using a scanning electron microscope (SEM) or a transmission electron microscope (TEM).

The aspect ratio (the average value of the maximum length/the thickness) of the plate-like particle is, for example, 2 or more and 10000 or less, or preferably 10 or more and 5000 or less.

When the aspect ratio of the plate-like particle exceeds the above-described range, the thermal conductive sheet may become fragile. When the aspect ratio of the plate-like particle is below the above-described range, the thermal conductivity in the plane direction may be reduced.

The average value of the maximum length and the thickness of the plate-like particle are measured by, for example, a light scattering method. To be specific, the average particle size is a volume average particle size measured with a dynamic light scattering type particle size distribution analyzer.

As the plate-like particle, a commercially available product or processed goods thereof can be used.

An example of the commercially available product includes a commercially available product of the plate-like boron nitride particle. To be specific, examples of the commercially available product of the plate-like boron nitride particle include the “PT” series (for example, “PT-110”) manufactured by Momentive Performance Materials Inc., and the “SHOBN®UHP” series (for example, “SHOBN®UHP-1”) manufactured by Showa Denko K.K.

The non-plate-like shape is a shape other than the plate-like shape and examples of the non-plate-like shape include a sphere-like shape, a block-like shape (an irregular shape excluding the sphere-like shape), and a needle-like shape. The non-plate-like particle is a particle in a shape other than the plate-like shape and examples thereof include a sphere-like particle, a block-like particle, and a needle-like particle. Preferably, a sphere-like particle and a block-like particle are used.

An example of the non-plate-like particle includes a non-plate-like particle made of the above-described inorganic component. Preferably, a non-plate-like particle made of an oxide (a non-plate-like oxide particle) is used, or more preferably, a non-plate-like particle made of a metal oxide (a non-plate-like metal oxide particle) is used. Also, preferably, a non-plate-like particle made of a hydroxide (a non-plate-like hydroxide particle) is used, or more preferably, a non-plate-like particle made of a metal hydroxide (a non-plate-like metal hydroxide particle) is used. Also, preferably, a non-plate-like particle made of a nitride (a non-plate-like nitride particle) is used, or more preferably, a non-plate-like particle made of a metal nitride (a non-plate-like metal nitride particle) is used.

To be specific, an example of the non-plate-like metal oxide particle includes a sphere-like metal oxide particle such as a sphere-like aluminum oxide particle and a sphere-like titanium oxide particle. An example of the non-plate-like metal oxide particle also includes a needle-like metal oxide particle such as a needle-like iron oxide particle.

An example of the non-plate-like metal hydroxide particle includes a block-like metal hydroxide particle such as a block-like aluminum hydroxide particle.

An example of the non-plate-like metal nitride particle includes a sphere-like metal nitride particle such as a sphere-like aluminum nitride particle.

As the non-plate-like particle, more preferably, a sphere-like aluminum oxide particle, a block-like aluminum hydroxide particle, and a sphere-like aluminum nitride particle (that is, a non-plate-like particle made of an aluminum compound) are used.

These non-plate-like particles can be used alone or in combination of two or more.

The average value of the maximum length (the average particle size) of the non-plate-like particle is, for example, 1 to 100 μm, preferably 3 to 90 μm, or more preferably 10 to 80 μm.

The average value of the maximum length (the average particle size) of the non-plate-like particle is measured by, for example, a light scattering method. To be specific, the average value of the maximum length (the average particle size) of the non-plate-like particle is a volume average particle size measured with a dynamic light scattering type particle size distribution analyzer.

The average value of the length in a direction perpendicular to the maximum length direction of the non-plate-like particle is, for example, 1 to 100 μm, preferably 3 to 90 μm, or more preferably 10 to 80 μm.

The average value of the length in a direction perpendicular to the maximum length direction of the non-plate-like particle is measured using a scanning electron microscope (SEM) or a transmission electron microscope (TEM).

The aspect ratio (the average value of the maximum length/the average value of the length in a direction perpendicular to the maximum length direction) of the non-plate-like particle is, for example, 1 or more and 10000 or less, or preferably 1 or more and less than 2.

To be specific, when the non-plate-like particle is a block-like particle, the aspect ratio of the non-plate-like particle is, for example, less than 2, or preferably 1.5 or less, and is usually 1 or more. When the non-plate-like particle is a needle-like particle, the aspect ratio of the non-plate-like particle is, for example, 2 to 10000, or preferably 10 to 5000. When the non-plate-like particle is a sphere-like particle, the aspect ratio of the non-plate-like particle is substantially 1.

As the non-plate-like particle, a commercially available product or processed goods thereof can be used.

An example of the commercially available product includes a commercially available product of a block-like aluminum hydroxide particle and a block-like aluminum oxide particle.

To be specific, an example of the commercially available product of the block-like aluminum hydroxide particle includes the “H” series (for example, “H-10” and “H-10ME”) manufactured by Showa Denko K.K.

Also, to be specific, an example of the commercially available product of the block-like aluminum oxide particle includes the “AS” series (for example, “AS-10” and “AS-50”) manufactured by Showa Denko K.K.

The filler may be, in view of fluidity thereof, subjected to a surface treatment by a known method with a silane coupling agent or the like as required.

The content ratio of the filler with respect to the thermal conductive sheet is, for example, 30 to 99 mass %, preferably 50 to 95 mass %, or more preferably 60 to 90 mass % on the mass basis. The content ratio of the filler with respect to the thermal conductive sheet is, for example, 40 volume % or more, preferably 40 to 95 volume %, or more preferably 40 to 90 volume % on the volume basis.

In the filler, the content ratio R (the plate-like particle/the non-plate-like particle) of the plate-like particle with respect to the non-plate-like particle is, for example, 4/3 to 6/1, preferably 5/2 to 6/1, or more preferably 3/1 to 6/1 on the volume basis.

In other words, the content ratio of the plate-like particle with respect to the total amount of the plate-like particle and the non-plate-like particle is, for example, 50 to 99 volume %, preferably 52 to 95 volume %, or more preferably 55 to 90 volume % on the volume basis. The content ratio of the non-plate-like particle with respect to the total amount of the plate-like particle and the non-plate-like particle is, for example, 1 to 50 volume %, preferably 5 to 48 volume %, or more preferably 10 to 45 volume % on the volume basis.

When the content ratio R of the plate-like particle with respect to the non-plate-like particle exceeds the above-described range, the thermal conductive sheet may become fragile. When the content ratio R of the plate-like particle with respect to the non-plate-like particle is below the above-described range, the thermal conductivity in the plane direction may be reduced.

Examples of the resin include a thermosetting resin and a thermoplastic resin.

Examples of the thermosetting resin include an epoxy resin, a thermosetting polyimide, a phenol resin, and a silicone resin.

Examples of the thermoplastic resin include polyolefin (for example, polyethylene, polypropylene, an ethylene-propylene copolymer), an acrylic resin (for example, polymethyl methacrylate), and polyvinyl acetate.

As the resin, preferably, a thermosetting resin is used, or more preferably an epoxy resin is used.

The epoxy resin is in a liquid state, in a semi-solid state, or in a solid state at normal temperature. Preferably, the epoxy resin is in a solid state.

To be specific, examples of the epoxy resin include an aromatic epoxy resin such as a bisphenol epoxy resin (for example, a bisphenol A epoxy resin, a bisphenol F epoxy resin, a bisphenol S epoxy resin, a hydrogenated bisphenol A epoxy resin, a dimer acid-modified bisphenol epoxy resin, and the like), a novolak epoxy resin (for example, a phenol novolak epoxy resin, a cresol novolak epoxy resin, a biphenyl epoxy resin, and the like), a naphthalene epoxy resin, a fluorene epoxy resin (for example, a bisaryl fluorene epoxy resin and the like), and a triphenylmethane epoxy resin (for example, a trishydroxyphenylmethane epoxy resin and the like); a nitrogen-containing-cyclic epoxy resin such as triepoxypropyl isocyanurate (triglycidyl isocyanurate) and a hydantoin epoxy resin; an aliphatic epoxy resin; an alicyclic epoxy resin (for example, a dicyclo ring-type epoxy resin and the like); a glycidylether epoxy resin; and a glycidylamine epoxy resin.

These epoxy resins can be used alone or in combination of two or more.

As the epoxy resin, preferably, two or more epoxy resins having properties different from each other are used in combination.

The epoxy equivalent of the epoxy resin is, for example, 100 to 1000 g/eqiv., or preferably 150 to 700 g/eqiv. When two epoxy resins having properties different from each other are used in combination, the epoxy equivalent of one epoxy resin is preferably 100 to 300 g/eqiv., and the epoxy equivalent of the other epoxy resin is preferably 500 to 1000 g/eqiv.

The softening temperature (a ring and ball test) of the epoxy resin is, for example, 20 to 85° C., or preferably 40 to 80° C.

The melt viscosity of the epoxy resin at 150° C. is, for example, 1 Pa·s or less, or preferably 0.1 Pa·s or less, and is usually 0.0001 Pa·s or more.

The kinetic viscosity of the epoxy resin measured by a kinetic viscosity test (temperature: 25° C.±0.5° C., solvent: butyl carbitol, resin (solid content) concentration: 40 mass %) in conformity with JIS K 7233 (a bubble viscometer method) (1986) is, for example, 1×10⁻⁴ to 4×10⁻⁴ m²/s, or preferably 1.5×10⁻⁴ to 3×10⁻⁴ m²/s.

In the kinetic viscosity test in conformity with JIS K 7233 (the bubble viscometer method) (1986), the kinetic viscosity of the epoxy resin is measured by comparing the bubble rising rate of a resin sample with the bubble rising rate of criterion samples (having a known kinetic viscosity) and determining the kinetic viscosity of the criterion sample having a matching rising rate to be the kinetic viscosity of the epoxy resin.

The epoxy resin can contain, for example, a curing agent and a curing accelerator to be prepared as an epoxy resin composition.

The curing agent is a latent curing agent (an epoxy resin curing agent) which can cure the epoxy resin by heating and examples thereof include a phenol compound, an acid anhydride compound, an amide compound, a hydrazide compound, an imidazoline compound, a urea compound, and a polysulfide compound. Preferably, a phenol compound is used. These curing agents can be used alone or in combination of two or more.

The phenol compound is, for example, in a solid state. The softening point thereof is, for example, 50 to 100° C. and the hydroxyl group equivalent thereof is, for example, 100 to 250 (g/eqiv.).

Examples of the curing accelerator include an imidazole compound such as 2-phenylimidazole, 2-methylimidazole, 2-ethyl-4-methylimidazole, and 2-phenyl-4-methyl-5-hydroxymethylimidazole; a tertiary amine compound such as triethylenediamine and tri-2,4,6-dimethylaminomethylphenol; a phosphorus compound such as triphenylphosphine, tetraphenylphosphoniumtetraphenylborate, and tetra-n-butylphosphonium-o,o-diethylphosphorodithioate; a quaternary ammonium salt compound; an organic metal salt compound; and derivatives thereof. Preferably, an imidazole compound is used.

These curing accelerators can be used alone or in combination of two or more.

The content ratio of the curing agent with respect to 100 parts by mass of the epoxy resin is, for example, 0.5 to 50 parts by mass, or preferably 1 to 40 parts by mass. The content ratio of the curing accelerator is, for example, 0.1 to 10 parts by mass, or preferably 0.2 to 5 parts by mass.

The content proportion of the epoxy resin in the epoxy resin composition is the remaining portions of the above-described curing agent and curing accelerator.

The above-described curing agent and/or curing accelerator can be prepared as a solvent solution and/or a solvent dispersion liquid which is obtained by being dissolved and/or dispersed by a solvent as required.

An example of the solvent includes an organic solvent including a ketone such as acetone and methyl ethyl ketone, an ester such as ethyl acetate, and an amide such as N,N-dimethylformamide. Examples of the solvent include an aqueous solvent such as water and alcohol such as methanol, ethanol, propanol, and isopropanol.

The content ratio of the resin with respect to the thermal conductive sheet is, for example, 1 to 70 mass %, preferably 5 to 50 mass %, or more preferably 10 to 40 mass % on the mass basis.

The content ratio of the resin with respect to the thermal conductive sheet is, for example, 60 volume % or less, preferably 5 to 60 volume %, or more preferably 10 to 60 volume % on the volume basis.

The content ratio of the resin with respect to 100 parts by mass of the filler is, for example, 0.5 to 20 parts by mass, or preferably 1 to 10 parts by mass.

The above-described filler and resin are blended at the above-described content proportion, so that the thermal conductive sheet can be obtained by a method to be described later.

An additive such as an antioxidant and a stabilizer can be added into the thermal conductive sheet of the present invention at an appropriate proportion as long as it does not damage the effect of the present invention.

Next, the method for producing one embodiment of the thermal conductive sheet of the present invention is described in details.

In this method, first, a filler, a resin, and an additive added as required are blended at the above-described content proportion to be stirred and mixed, so that a resin composition is prepared (preliminarily prepared) (a preliminarily preparing step).

In the mixing, in order to efficiently stir the components, for example, the solvent is blended therein with the above-described components.

An example of the solvent includes the same organic solvent as that described above. Preferably, a ketone is used. When the above-described curing agent and/or curing accelerator are prepared as a solvent solution and/or a solvent dispersion liquid, the solvent of the solvent solution and/or the solvent dispersion liquid can also serve as a mixing solvent for the stirring and mixing without adding a solvent during the stirring and mixing. Alternatively, a solvent can be further added as a mixing solvent in the stirring and mixing.

The mixing ratio of the solvent with respect to 100 parts by mass of the resin composition is, for example, 1 to 1000 parts by mass, or preferably 10 to 100 parts by mass.

When the stirring and mixing is performed using a solvent, the solvent is removed after the stirring and mixing.

In order to remove the solvent, the mixture is, for example, allowed to stand at room temperature for 1 to 48 hours; is, for example, heated at 40 to 100° C. for 0.5 to 3 hours; or is, for example, heated under a reduced pressure atmosphere of 0.001 to 50 kPa at 20 to 60° C. for 0.5 to 3 hours.

Next, in this method, the obtained resin composition is formed into a sheet shape by a hot pressing (a sheet forming step).

To be specific, the resin composition is formed into a sheet shape by the hot pressing via a release sheet.

That is, first, the release sheet is prepared. Examples of the release sheet include a metal foil such as a stainless foil and a resin sheet such as a polyester film. Preferably, a resin sheet is used. The thickness of the release sheet is, for example, 5 to 1000 μm, or preferably 10 to 500 μm. The top surface of the release sheet can be subjected to a release treatment.

Thereafter, the resin composition is disposed on the prepared release sheet.

To be specific, the resin composition is placed (put) on the release sheet in a block-like shape.

Next, another release sheet is prepared to be disposed on the release sheet on which the resin composition in a block-like shape is already disposed so as to cover the resin composition in a block-like shape.

In this way, a laminate in which the resin composition is sandwiched between two release sheets in the thickness direction is fabricated.

Next, the laminate is hot pressed in the thickness direction.

The hot pressing conditions are as follows: a temperature of, for example, 50 to 150° C., or preferably 60 to 150° C.; a pressure of, for example, 1 to 100 MPa, or preferably 5 to 50 MPa; and a duration of, for example, 0.1 to 100 minutes, or preferably 1 to 10 minutes.

More preferably, the resin composition is hot pressed under vacuum. The degree of vacuum in the vacuum hot pressing is, for example, 1 to 100 Pa, or preferably 5 to 50 Pa. The temperature, the pressure, and the duration thereof are the same as those in the above-described hot pressing.

Thereafter, the resin composition formed into a sheet shape is taken out to be cooled to the room temperature, so that the thermal conductive sheet is obtained.

The thermal conductive sheet (the epoxy resin contained in the thermal conductive sheet) is brought into a B-stage state (a semi-cured state) by the hot pressing.

The thickness of the thermal conductive sheet is, for example, 1 mm or less, preferably 0.8 mm or less, and is usually, for example, 0.05 mm or more, or preferably 0.1 mm or more.

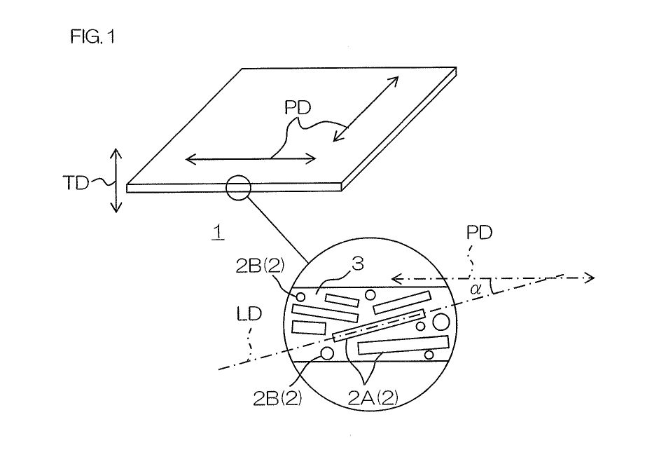

In a thermal conductive sheet 1 obtained in this way, as shown in FIG. 1 and its partially enlarged schematic view, a longitudinal direction LD of a plate-like particle 2A is oriented along a plane direction PD which crosses (is perpendicular to) a thickness direction TD of the thermal conductive sheet 1.

The calculated average of the angle formed between the longitudinal direction LD of the plate-like particle 2A and the plane direction PD of the thermal conductive sheet 1 (an orientation angle α of the plate-like particle 2A with respect to the thermal conductive sheet 1) is, for example, 25 degrees or less, or preferably 20 degrees or less, and is usually 0 degree or more.

The orientation angle α of the plate-like particle 2A with respect to the thermal conductive sheet 1 is obtained as follows: the thermal conductive sheet 1 is cut along the thickness direction TD with a cross section polisher (CP); the cross section thus appeared is photographed with a scanning electron microscope (SEM) at a magnification that enables observation of 200 or more plate-like particles 2A in the field of view; a tilt angle α between the longitudinal direction LD of the plate-like particle 2A and the plane direction PD of the thermal conductive sheet 1 is obtained from the obtained SEM photograph; and the average value of the tilt angles α is calculated.

On the other hand, in a resin 3, non-plate-like particles 2B are uniformly dispersed between the plate-like particles 2A.

The peeling adhesive force of the thermal conductive sheet 1 with respect to a copper foil is 2 N/10 mm or more.

When the peeling adhesive force of the thermal conductive sheet 1 with respect to a copper foil is below the above-described range, the adhesive force with respect to an adherend is reduced.

The peeling adhesive force of the thermal conductive sheet 1 with respect to a copper foil is preferably 2.1 N/10 mm or more, more preferably 2.3 N/10 mm or more, or particularly preferably 2.5 N/10 mm or more, and is usually 100 N/10 mm or less.

The peeling adhesive force of the thermal conductive sheet 1 with respect to a copper foil is measured as follows.

That is, first, the thermal conductive sheet 1 is cut into an appropriate size. A release sheet on one side (not shown in FIG. 1) thereof is peeled off and the thermal conductive sheet 1 is overlapped with a rough surface of the copper foil so as to be in contact therewith, so that a copper foil laminate sheet is fabricated.

The copper foil has the rough surface at one side in the thickness direction and a flat surface at the other side in the thickness direction. The surface roughness Rz (the ten point height of irregularities in conformity with JIS B0601-1994) of the rough surface is 5 to 20 μm. The thickness of the copper foil is, for example, 10 to 200 μm, or, to be specific, 70 μm.

Next, the fabricated copper foil laminate sheet is disposed in a vacuum hot press to be hot pressed at a pressure of 20 to 50 MPa for 1 to 10 minutes. Subsequently, in a state where the pressure is maintained, the temperature is increased to, for example, 120 to 180° C. to be maintained for 1 to 10 minutes.

By the above-described hot pressing, the thermal conductive sheet 1 (the epoxy resin contained in the thermal conductive sheet 1) is cured by heat (is brought into a C-stage state).

The thermal conductivity (TC1 and TC2) of the thermal conductive sheet 1 is substantially the same before and after the curing by heat.

Thereafter, the copper foil laminate sheet is taken out from the vacuum hot press. The obtained copper foil laminate sheet is allowed to stand until it is cooled to room temperature. Thereafter, the copper foil laminate sheet is cut into an appropriate size to fabricate a test piece. A 90-degree peeling test is performed by using the fabricated test piece with a universal testing machine (rate: 10 mm/min).

The thermal conductivity TC1 in the thickness direction TD of the thermal conductive sheet 1 is 4 W/m·K or more.

When the thermal conductivity TC1 in the thickness direction TD of the thermal conductive sheet 1 is below the above-described range, the thermal conductivity in the thickness direction TD is reduced.

The thermal conductivity TC1 in the thickness direction TD of the thermal conductive sheet 1 is preferably 6 W/m·K or more, more preferably 7 W/m·K or more, particularly preferably 9 W/m·K or more, and is usually 50 W/m·K or less.

The thermal conductivity TC1 in the thickness direction TD of the thermal conductive sheet 1 is measured by, for example, a xenon flash method (a method of applying a xenon flash light to the thermal conductive sheet 1).

In addition, the thermal conductivity TC2 in the plane direction PD of the thermal conductive sheet 1 is 20 W/m·K or more.

When the thermal conductivity TC2 in the plane direction PD of the thermal conductive sheet 1 is below the above-described range, the thermal conductivity in the plane direction PD is reduced.

The thermal conductivity TC2 in the plane direction PD of the thermal conductive sheet 1 is preferably 35 W/m·K or more, or more preferably 40 W/m·K or more, and is usually 150 W/m·K or less.

The thermal conductivity TC2 in the plane direction PD of the thermal conductive sheet 1 is measured by, for example, a xenon flash method.

The ratio (TC2/TC1) of the thermal conductivity TC2 in the plane direction PD with respect to the thermal conductivity TC1 in the thickness direction TD of the thermal conductive sheet 1 is 3 or more.

When the ratio (TC2/TC1) of the thermal conductivity TC2 in the plane direction PD with respect to the thermal conductivity TC1 in the thickness direction TD of the thermal conductive sheet 1 is below the above-described range, the thermal conductivity in the plane direction PD is reduced.

The ratio (TC2/TC1) of the thermal conductivity TC2 in the plane direction PD with respect to the thermal conductivity TC1 in the thickness direction TD of the thermal conductive sheet 1 is preferably 4 or more, more preferably 5 or more, or particularly preferably 7 or more, and is usually 20 or less.

The peeling adhesive force of the thermal conductive sheet 1 with respect to the copper foil is 2 N/10 mm or more, so that the thermal conductive sheet 1 has an excellent adhesive force.

The thermal conductive sheet 1 has the thermal conductivity TC1 in the thickness direction TD of 4 W/m·K or more, the thermal conductivity TC2 in the plane direction PD with respect to the thickness direction TD of 20 W/m·K (or more, and the ratio (TC2/TC1) of the thermal conductivity TC2 in the plane direction PD with respect to the thermal conductivity TC1 in the thickness direction TD of 3 or more, so that it has an excellent thermal conductivity in the plane direction PD.

Therefore, the thermal conductive sheet 1 has both an excellent adhesiveness and an excellent thermal conductivity in the plane direction PD.

Therefore, the thermal conductive sheet 1, as a thermal conductive sheet having an excellent thermal conductivity in the plane direction PD while having an excellent adhesiveness, can be used for various heat dissipating applications.

Accordingly, in power electronics technology or the like which uses semiconductor elements to convert and control electric power used in, for example, hybrid devices, high-brightness LED devices, and electromagnetic induction heating devices, the thermal conductive sheet 1 can be used as a heat dissipating member for converting a high current to heat or the like. To be specific, for example, the thermal conductive sheet 1 can be preferably used as a heat dissipating member adhered to a semiconductor element used in a light emitting diode device, an imaging element used in an image-taking device, a back light of a liquid crystal display device, and furthermore, other various power modules for dissipating heat from the member. That is, when the thermal conductive sheet 1 is adhered to a semiconductor element, even in a case where the semiconductor element is heated, the heat can be released in the plane direction PD.

The thermal conductive sheet 1 can be cured by heat using the heat of the semiconductor element. Alternatively, the thermal conductive sheet 1 can be cured in such a way that after the thermal conductive sheet 1 is attached to the semiconductor element, the thermal conductive sheet 1 is separately heated. The conditions of the curing by heat are as follows: a temperature of, for example, 60 to 250° C., or preferably 80 to 200° C.

To be specific, the thermal conductive sheet 1 is preferably used as, for example, a heat spreader or a heat sink of the light emitting diode device; a heat dissipating sheet attached to a casing of the liquid crystal display device or the image-taking device; or an encapsulating material for encapsulating an electronic circuit board.

### EXAMPLES

While the present invention will be described hereinafter in further detail with reference to Examples and Comparative Examples, the present invention is not limited to these Examples and Comparative Examples.

### Example 1

MEHC-7800S (a phenol compound, a curing agent, solid, a softening point of 61 to 89° C., a hydroxyl group equivalent of 173 to 177 g/eqiv., manufactured by MEIWA PLASTIC INDUSTRIES, LTD.) was mixed with MEHC-7800SS (a phenol compound, a curing agent, solid, a softening point of 61 to 89° C., a hydroxyl group equivalent of 173 to 177 g/eqiv., manufactured by MEIWA PLASTIC INDUSTRIES, LTD.) at a weight ratio of 6:4, so that a curing agent mixture was prepared.

Next, 0.614 g of YSLV-80XY (a bisphenol epoxy resin, solid, an epoxy equivalent of 180 to 210 (g/eqiv.), a melting point of 75 to 85° C., a melt viscosity (at 150° C.) of 0.01 Pa·s or less, manufactured by Nippon Steel Chemical Co., Ltd.); 0.614 g of JER1002 (a bisphenol epoxy resin, solid, an epoxy equivalent of 600 to 700 (g/eqiv.), a softening point of 78° C., a kinetic viscosity (at 25° C.) of 1.65×10⁻⁴ to 2.75×10⁻⁴ (m²/s), manufactured by Mitsubishi Chemical Corporation); 0.338 g of the curing agent mixture; and 0.0061 g of 2P4MHZ-PW (an imidazole compound, a curing accelerator, manufactured by Shikoku Chemicals Corporation) were dissolved in 5 g of acetone, so that an epoxy resin solution was prepared.

6.00 g of PT-110 (a plate-like boron nitride particle, an average particle size (the average value of the maximum length, a light scattering method) of 45 μm, thickness of 2 to 5 mm (SEM), an aspect ratio of 10 to 25, manufactured by Momentive Performance Materials Inc.) and 1.73 g of AS-10 (a sphere-like aluminum hydroxide particle, an average particle size (the average value of the maximum length, a light scattering method) of 50 μm, an aspect ratio: 1, manufactured by Showa Denko K.K.), as fillers, were mixed with the prepared epoxy resin solution to be stirred and thereafter, the acetone was removed under a reduced pressure, so that a resin composition was prepared.

Next, 1 g of the resin composition was placed on a release sheet (MRN38, a thickness of 38 μm, a polyester film, manufactured by Mitsubishi Polyester Film GmbH) which was subjected to a release treatment and subsequently, another release sheet was disposed on the release sheet on which the resin composition was already placed so as to cover the resin composition. In this way, the resin composition was sandwiched between two release sheets, so that a laminate was fabricated.

Next, the laminate was hot pressed under the conditions shown in Table 1 using a vacuum hot press, so that the resin composition was formed into a sheet shape. Thereafter, the resin composition in a sheet shape was taken out to be cooled to the room temperature, so that a thermal conductive sheet was obtained.

That is, the laminate was sequentially hot pressed under a press condition 1 and a press condition 2, so that a thermal conductive sheet having a thickness of 200 μm for thermal conductivity evaluation in Evaluation 1. to be described later was obtained. Also, the laminate was hot pressed only under a press condition 1, so that a thermal conductive sheet having a thickness of 200 μm for peeling adhesive force evaluation in Evaluation 2. to be described later was obtained.

TABLE 1
Production Conditions of Thermal Conductive Sheet

| | Press Condition 1 | | | Press Condition 2 | | |
|---|---|---|---|---|---|---|
| | Temper- | | Dura- | Temper- | | Dura- |
| | ature | Pressure | tion | ature | Pressure | tion |
| | (° C.) | (MPa) | (min) | (° C.) | (MPa) | (min) |
| For Thermal | 80 | 30 | 5 | 150 | 30 | 15 |
| conductivity | | | | | | |
| Evaluation | | | | | | |
| 90-Degree | 80 | 30 | 5 | — | — | — |
| Peeling Test | | | | | | |

### Examples 2 to 6 and Comparative Examples 1 to 3

Thermal conductive sheets were obtained in the same manner as in Example 1, except that the mixing formulation of the filler was changed in accordance with the description in Table 2.

The details of AS-50 in Examples 4 to 6 are as follows.

AS-50: trade name, a sphere-like aluminum oxide particle, an average particle size (a light scattering method) of 10 μm, manufactured by Showa Denko K.K.

TABLE 2

| | | | | | | | | |
|---|---|---|---|---|---|---|---|---|
| | | | | | | Comp. | Comp. | Comp. |
| Ex. 1 | Ex. 2 | Ex. 3 | Ex. 4 | Ex. 5 | Ex. 6 | Ex. 1 | Ex. 2 | Ex. 3 |

| Filler | Plate-Like | Type | PT-110 | PT-110 | PT-110 | PT-110 | PT-110 | PT-110 | PT-110 | PT-110 | PT-110 |
|---|---|---|---|---|---|---|---|---|---|---|---|
| | Particle | Volume | 60 | 50 | 40 | 60 | 50 | 40 | 70 | 30 | 21.7 |
| | | (%) | | | | | | | | | |
| | | Weight | 6.0 | 5.0 | 4.0 | 6.0 | 5.0 | 4.0 | 7.0 | 3.0 | 2.5 |
| | | (g) | | | | | | | | | |
| | Non-Plate-Like | Type | AS-10 | AS-10 | AS-10 | AS-50 | AS-50 | AS-50 | — | — | AS-10 |
| | Particle | Volume | 10 | 20 | 30 | 10 | 20 | 30 | — | — | 20.1 |
| | | (%) | | | | | | | | | |
| | | Weight | 1.73 | 3.46 | 5.19 | 1.73 | 3.46 | 5.19 | — | — | 4.01 |
| | | (g) | | | | | | | | | |
| Epoxy | YSLV-80XY (g) | | 0.614 | 0.614 | 0.614 | 0.614 | 0.614 | 0.614 | 0.614 | 0.614 | 1.372 |
| Resin | JER1002 (g) | | 0.614 | 0.614 | 0.614 | 0.614 | 0.614 | 0.614 | 0.614 | 0.614 | 1.372 |
| Curing Agent (g) | | | 0.338 | 0.338 | 0.338 | 0.338 | 0.338 | 0.338 | 0.338 | 0.338 | 0.755 |
| Imidazole Curing Accelerator | | | 0.0061 | 0.0061 | 0.0061 | 0.0061 | 0.0061 | 0.0061 | 0.0061 | 0.0061 | 0.0137 |
| 2P4MHZ-PW (g) | | | | | | | | | | | |
| Thermal | Density (g/cm³) | | 2.10 | 2.23 | 2.40 | 2.06 | 2.03 | 2.23 | 1.90 | 1.50 | 1.95 |
| Conductive | Thermal | Plane | 43.5 | 39.3 | 32.0 | 40.4 | 28.7 | 21.2 | 56.1 | 1.0 | 0.5 |
| Sheet | Conductivity | Direction | | | | | | | | | |
| | (W/m · K) | (TC2) | | | | | | | | | |
| | | Thickness | 5.8 | 8.6 | 9.3 | 5.7 | 6.2 | 5.8 | 4.5 | 0.5 | 0.5 |
| | | Direction | | | | | | | | | |
| | | (TC1) | | | | | | | | | |
| | | TC2/TC1 | 7.4 | 4.5 | 3.5 | 7.1 | 4.6 | 3.7 | 12.6 | 2.0 | 1.0 |

| | | | | | | | | | |
|---|---|---|---|---|---|---|---|---|---|
| Peeling Adhesive Force | 2.0 | 2.4 | 2.6 | 2.2 | 2.2 | 2.4 | 1.3 | 9.4 | 8.0 |
| (N/10 mm) | | | | | | | | | |

(Evaluation)

### 1. Density

The density of the thermal conductive sheets for thermal conductivity evaluation obtained in Examples and Comparative Examples was measured. The results are shown in Table 2.

### 2. Thermal Conductivity

(1) Thermal Conductivity in Thickness Direction (TC1)

The thermal conductive sheets for thermal conductivity evaluation obtained in Examples and Comparative Examples were cut into squares each having a size of 1 cm×1 cm to obtain cut pieces. A carbon spray (an alcohol dispersion solution of carbon) was applied to the entire top surfaces (one side surfaces in the thickness direction) of the cut pieces to be dried. The applied portions were defined as light receiving portions. The carbon spray was applied to the entire back surfaces (the other side surfaces in the thickness direction) of the cut pieces and the applied portions were defined as detected portions.

Next, a xenon flash light was applied to the light receiving portions to detect the temperature of the detected portions, so that the thermal diffusivity in the thickness direction (D1) was measured. The thermal conductivity in the thickness direction (TC1) of the thermal conductive sheet was obtained from the obtained thermal diffusivity (D1) by the following formula. The results are shown in Table 2.

TC1=D1×ρ×Cp

ρ: the density of the thermal conductive sheet at 25° C.

Cp: the specific heat of the thermal conductive sheet (substantially 0.9)

(2) Thermal Conductivity in Plane Direction (TC2)

The thermal conductive sheets for thermal conductivity evaluation obtained in Examples and Comparative Examples were cut into circular shapes each having a diameter of 2.6 cm to obtain cut pieces. A carbon spray was applied to the central portions in the top surfaces of the cut pieces in circular shapes to be dried. The applied portions were defined as light receiving portions. The carbon spray was applied to the circumference portions at spaced intervals to the central portions in the back surfaces of the cut pieces outwardly in a radial direction in ring (circular ring) shapes to be dried and the applied portions were defined as detected portions.

Next, a xenon flash light was applied to the light receiving portions to detect the temperature of the detected portions, so that the thermal diffusivity in the plane direction (D2) was measured. The thermal conductivity in the plane direction (TC2) of the thermal conductive sheet was obtained from the obtained thermal diffusivity (D2) by the following formula. The results are shown in Table 2.

TC2=D2×ρ×Cp

ρ: the density of the thermal conductive sheet at 25° C.

Cp: the specific heat of the thermal conductive sheet (substantially 0.9)

### 3. Peeling Adhesive Force (90-Degree Peeling Test)

The thermal conductive sheets for peeling adhesive force evaluation obtained in Examples and Comparative Examples were cut into rectangular shapes each having a size of 4×10 cm. Each of the cut pieces was overlapped with a rough surface (the surface roughness Rz: 12 μm, in conformity with JIS B0601-1994) of a copper foil (10 cm×10 cm, a thickness of 70 μm, GTS-MP, manufactured by FURUKAWA ELECTRIC CO., LTD.) so as to be in contact therewith, so that a copper foil laminate sheet was fabricated.

The fabricated copper foil laminate sheet was disposed in a vacuum hot press set at 80° C. to be hot pressed at a pressure of 30 MPa for 3 minutes. Subsequently, in a state where the pressure was maintained, the temperature was increased to 150° C. to be maintained for 10 minutes.

Thereafter, the copper foil laminate sheet was taken out from the vacuum hot press. The obtained copper foil laminate sheet was allowed to stand until it was cooled to room temperature. Thereafter, the copper foil laminate sheet was cut into a size of 1×10 cm to fabricate a test piece. The fabricated test piece was subjected to a 90-degree peeling test with an autograph (manufactured by Shimadzu Corporation) (rate: 10 mm/min). The results are shown in Table 2.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A thermal conductive sheet having:
a peeling adhesive force with respect to a copper foil of 2 N/10 mm or more,
a thermal conductivity in a thickness direction (TC1) of 4 W/m·K or more,
a thermal conductivity in a direction perpendicular to the thickness direction (TC2) of 20 W/m·K or more, and
a ratio (TC2/TC1) of the thermal conductivity in a direction perpendicular to the thickness direction (TC2) with respect to the thermal conductivity in the thickness direction (TC1) of 3 or more.

2. The thermal conductive sheet according to claim 1, wherein
the thermal conductive sheet contains a filler containing a plate-like particle and a non-plate-like particle, and an epoxy resin and
the content ratio of the filler is 40 volume % or more.

3. The thermal conductive sheet according to claim 2, wherein
the content ratio of the plate-like particle with respect to the non-plate-like particle is 4/3 to 6/1 on the volume basis.

4. The thermal conductive sheet according to claim 2, wherein
the aspect ratio of the plate-like particle is 2 or more and 10000 or less.

5. The thermal conductive sheet according to claim 2, wherein
the aspect ratio of the non-plate-like particle is 1 or more and less than 2.

6. The thermal conductive sheet according to claim 2, wherein
the plate-like particle is made of a boron nitride.

7. The thermal conductive sheet according to claim 2, wherein
the non-plate-like particle is made of at least one inorganic component selected from the group consisting of a metal oxide, a metal hydroxide, and a metal nitride.

8. The thermal conductive sheet according to claim 2, wherein
the non-plate-like particle is made of at least one aluminum compound selected from the group consisting of an aluminum oxide, an aluminum hydroxide, and an aluminum nitride.

9. The thermal conductive sheet according to claim 2, wherein
the average value of the maximum length of the plate-like particle is 1 to 100 μm.

10. The thermal conductive sheet according to claim 2, wherein
the average value of the maximum length of the non-plate-like particle is 1 to 100 μm.

11. A method for producing a thermal conductive sheet comprising the steps of:
preliminarily preparing a resin composition which contains a filler containing a plate-like particle and a non-plate-like particle, and an epoxy resin and in which the content ratio of the filler is 40 volume % or more; and
forming the resin composition into a sheet shape by a hot pressing.
